(19) United States
(12) Patent Application Publication
(10) Pub. No.: US 2021/0148099 A1
(43) Pub. Date: May 20, 2021

(54) Faucet

(71) Applicants: Huaqiang ZHOU, Xiamen (CN); Xiamen Water Nymph Sanitary Technology Co., Ltd., Xiamen (CN)

(72) Inventor: Huaqiang ZHOU, Xiamen (CN)

(21) Appl. No.: 17/162,999

(22) Filed: Jan. 29, 2021

(30) Foreign Application Priority Data
Dec. 24, 2020 (CN) 202023164451.9

(51) Int. Cl. E03C 1/04; F16K 31/58

(52) U.S. Cl. CPC E03C 1/0404; E03C 2001/0417; E03C 2001/0414; F16K 31/58

(57) ABSTRACT

The invention relates to the technical field of bath products and provides a faucet. The faucet comprises a water outlet part and a rotatable water outlet assembly. A water outlet end of the water outlet part is arranged horizontally, and the rotatable water outlet assembly is connected to the water outlet end. The water outlet assembly is rotatably arranged in the water outlet end and can rotate to allow water to be discharged upwards, downwards, leftwards, rightwards, forwards or backwards; in addition, the water outlet assembly can be pushed into the horizontal water outlet end to occupy less space when not used and to be protected.

### CROSS-REFERENCE TO RELATED APPLICATIONS

The application claims priority to Chinese patent application CN 202023164451.9, filed on Dec. 24, 2020, the entire contents of which are incorporated herein by reference.

### TECHNICAL FIELD

The invention relates to the technical field of bath products, in particular to a faucet.

### BACKGROUND

Most faucets in the prior art discharge water in only one direction and at a constant angle and have to be connected to a hose to change the water outlet angle, thus being inconvenient to use in many cases such as mouth rinsing and face washing.

### SUMMARY

The technical issue to be settled by the invention is to provide a faucet that is able to discharge water forwards and allows the water outlet direction to be adjusted freely.

The technical solution adopted by the invention to settle the above technical issue is as follows: a faucet comprises a water outlet part and a rotatable water outlet assembly, wherein a water outlet end of the water outlet part is arranged horizontally, and the rotatable water outlet assembly is connected to the water outlet end.

Furthermore, the water outlet assembly comprises a first ball and a connecting piece, wherein the first ball is rotatably arranged in the water outlet end, and a first water channel penetrates through the first ball and is connected to the water outlet end; one end of the connecting piece is connected to the first ball, a second water channel is formed in the connecting piece, the first water channel is communicated with the second water channel, and a water outlet is formed in the other end of the connecting piece.

Furthermore, the water outlet assembly further comprises a second ball and a water outlet component, wherein a third water channel penetrates through the second ball, the two ends of the connecting piece are connected to the first ball and the second ball respectively, and the first water channel, the second water channel and the third are communicated sequentially; and the second ball is rotatably arranged in the water outlet component.

Furthermore, the water outlet component is an aerator.

Furthermore, the connecting piece is bent.

Furthermore, the connecting piece is a hollow rod piece.

Furthermore, the connecting piece is a metal flexible hose.

Furthermore, the water outlet assembly further comprises a mating part, the first ball is rotatably arranged at one end of the mating part, and the other end of the mating part is connected to the water outlet end in a threaded manner.

Furthermore, the mating part extends out of the water outlet end, and anti-slip stripes are arranged on the circumferential surface of an extending section of the mating part.

The invention has the following beneficial effects: the water outlet assembly is rotatably arranged in the water outlet end and can rotate to allow water to be discharged upwards, downwards, leftwards, rightwards, forwards or backwards; in addition, the water outlet assembly can be pushed into the horizontal water outlet end to occupy less space when not used and to be protected.

### BRIEF DESCRIPTION OF DRAWINGS

FIG. 1 is structural diagram of a faucet in Embodiment 1 of the invention.

FIG. 2 is a schematic diagram of the faucet discharging water downwards in Embodiment 1 of the invention.

FIG. 3 is a schematic diagram of the faucet discharging water forwards in Embodiment 1 of the invention.

FIG. 4 is a schematic diagram of the faucet discharging water rightwards in Embodiment 1 of the invention.

FIG. 5 is a schematic diagram of the faucet discharging water backwards in Embodiment 1 of the invention.

FIG. 6 is a structural diagram of the faucet, used as a hidden faucet, in Embodiment 1 of the invention.

FIG. 7 is a structural diagram of the faucet, used as a kitchen faucet, in Embodiment 1 of the invention.

### DETAILED DESCRIPTION OF THE EMBODIMENTS

The technical contents, purposes and effects of the invention will be described in detail below in conjunction with the embodiments and accompanying drawings.

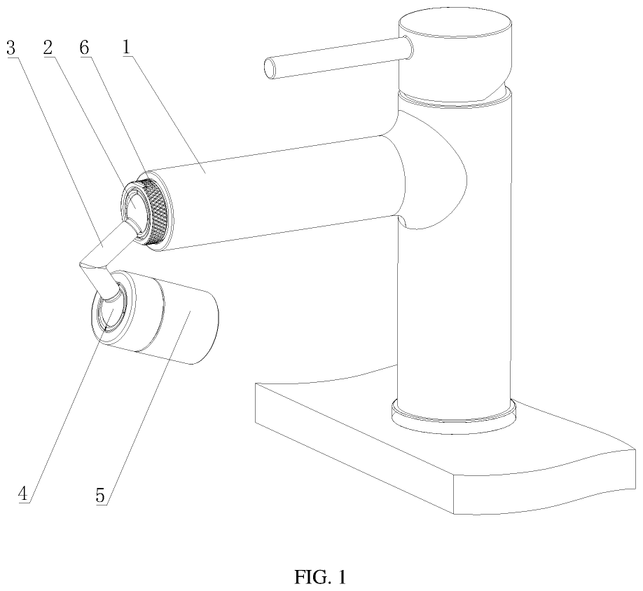

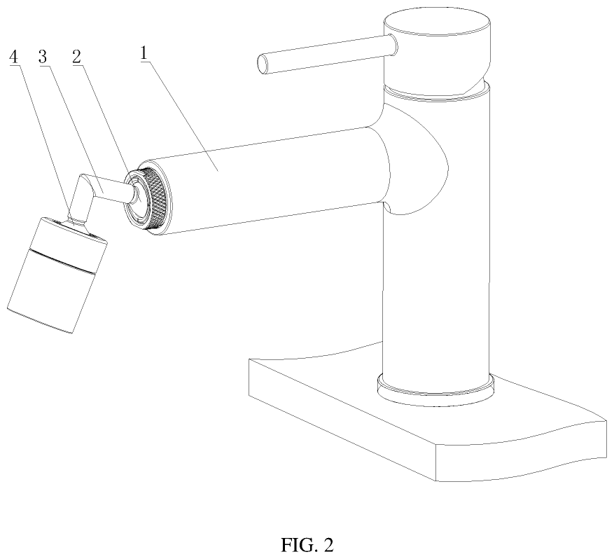

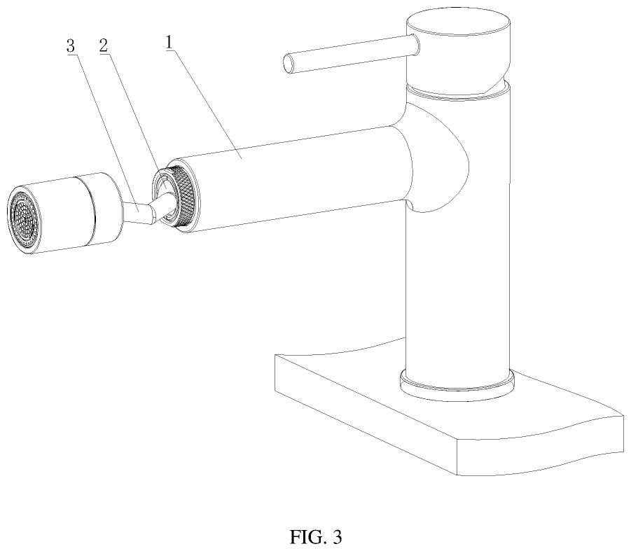

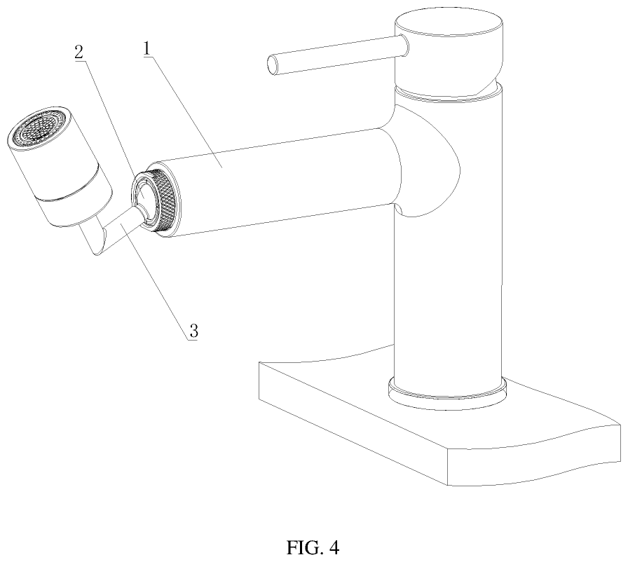

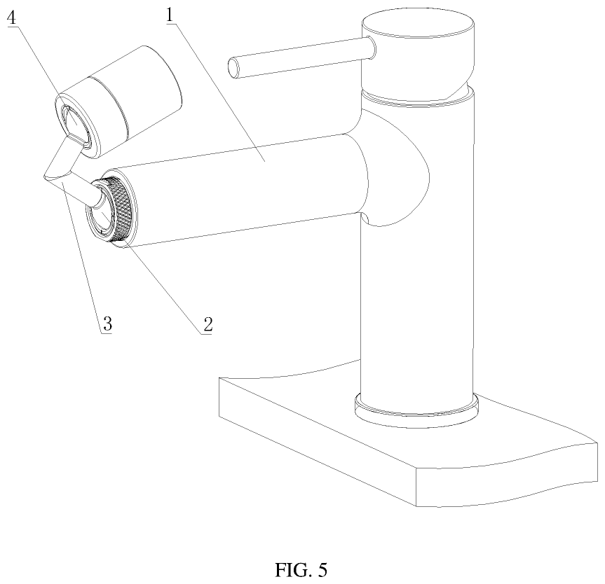

Referring to FIG. 1 to FIG. 5, a faucet comprises a water outlet part and a rotatable water outlet assembly, a water outlet end of the water outlet part is arranged horizontally, and the rotatable water outlet assembly is connected to the water outlet end.

From the above description, the invention has the following beneficial effects: the water outlet assembly is rotatably arranged in the water outlet end and can rotate to allow water to be discharged upwards, downwards, leftwards, rightwards, forwards or backwards; in addition, the water outlet assembly can be pushed into the horizontal water outlet end to occupy less space when not used and to be protected.

Furthermore, the water outlet assembly comprises a first ball and a connecting piece, the first ball is movably arranged in the water outlet end, and a first water channel penetrates through the first ball and is connected to the water outlet end; one end of the connecting piece is connected to the first ball, a second water channel is formed in the connecting piece, the first water channel is communicated with the second water channel, and a water outlet is formed in the other end of the connecting piece.

From the above description, during use, a user pulls the connecting piece outwards to drive the first ball to stretch out of the water outlet end; the ball can rotate to drive the connecting piece to swing to make the water outlet in the surface of one end of the connecting piece face upwards, downwards, leftwards, rightwards, forwards or backwards; at this moment, a faucet switch is rotated, and water discharged from the water outlet end flows out via the water outlet, the water outlet direction of which has been adjusted, along the first water channel of the first ball and the second water channel communicated with the first water channel.

Furthermore, the water outlet assembly further comprises a second ball and a water outlet component, a third water channel penetrates through the second ball, the two ends of the connecting piece are connected to the first ball and the second ball respectively, and the first water channel, the second water channel and the third water channel are communicated sequentially; and the second ball is rotatably arranged in the water outlet component.

From the above description, the second ball is rotatably arranged in the water outlet component, the horizontal water outlet end, the first water channel, the second water channel, the third water channel and the water outlet component are sequentially arranged, and the water outlet direction can be selected more flexibly by means of the rotation of the two balls.

Furthermore, the water outlet component is an aerator.

From the above description, when water is to be discharged, the water sequentially flows through the water outlet end, the first water channel, the second water channel and the third water channel to flow out of the aerator, and after the water flows through the aerator, different bubbles can be generated to meet user requirements.

Furthermore, the connecting piece is bent.

From the above description, the connecting piece is bent, so that the angle of the connecting piece can be adjusted within a wide range, and more water outlet angles can be provided.

Furthermore, the connecting piece is a hollow rod piece.

From the above description, the connecting piece is of a rod shape, so that water outlet assembly can be positioned after being rotated, and the stability of the water outlet position is ensured; and the rod piece is hollow and thus can be used as a water channel.

Furthermore, the connecting piece is a metal flexible hose.

From the above description, the connecting piece is a metal flexible hose, so that the bending angle of the connecting piece can be selected flexibly, and more water outlet directions and angles can be provided.

Furthermore, the water outlet assembly further comprises a mating part, the first ball is rotatably arranged at one end of the mating part, and the other end of the mating part is connected to the horizontal water outlet end in a threaded manner.

Furthermore, the mating part extends out of the water outlet end, and anti-slip stripes are arranged on the circumferential surface of an extending section of the mating part.

From the above description, the first ball is connected to the water outlet end in a threaded manner through the mating part, and the mating part extends out of the water outlet end, so that assembly and disassembly are easy; and the anti-slip stripes are arranged on the surface of the extending section of the mating part, so that slipping will not be caused by water during assembly and disassembly.

Referring to FIG. 1 to FIG. 7, Embodiment 1 of the invention is as follows:

This embodiment provides a faucet comprising a water outlet part and a rotatable water outlet assembly, a water outlet end 1 of the water outlet part is arranged horizontally, and the rotatable water outlet assembly is connected to the water outlet end 1.

The water outlet assembly comprises a first ball 2, a connecting piece 3, a second ball 4, a water outlet component 5 and a mating part 6. The first ball 2 is rotatably arranged in the water outlet end 1, and a first water channel penetrates through the first ball 2 and is connected to the water outlet end 1; one end of the connecting piece 3 is connected to the first ball 2, a second water channel is formed in the connecting piece 3, the first water channel is communicated with the second water channel, and a water outlet is formed in the other end of the connecting piece 3.

A third water channel penetrates through the second ball 4, two ends of the connecting piece 3 are connected to the first ball 2 and the second ball 4 respectively, and the first water channel, the second water channel and the third water channel are communicated sequentially; and the second ball 4 is rotatably arranged in the water outlet component 5 and is sealed by a rubber ring.

The connecting piece 3 is bent, and the bending angle of the connecting piece 3 is 30°-150°. Optionally, the connecting piece 3 is a metal flexible hose, and the bending angle of the metal flexible hose can be fixed freely; or, the connecting piece 3 is a rod piece with a constant angle, so that the stability in use is guaranteed.

The mating part 6 is a hollow cylinder having an end matched with the first ball 2, the first ball 2 is rotatably arranged at one end of the mating part 6 and is sealed by a rubber ring, and an external thread is arranged at the other end of the mating part 6 and is connected to an internal thread arranged at the water outlet end 1. Optionally, an internal thread is arranged at one end of the mating part 6 and is connected to an external thread arranged at the water outlet end 1.

The mating part 6 extends out of the water outlet end 1, and anti-slip stripes are arranged on the surface of an extending section of the mating part 6.

The water outlet component 5 is a common aerator on the market, and users can adjust water bubbles as required.

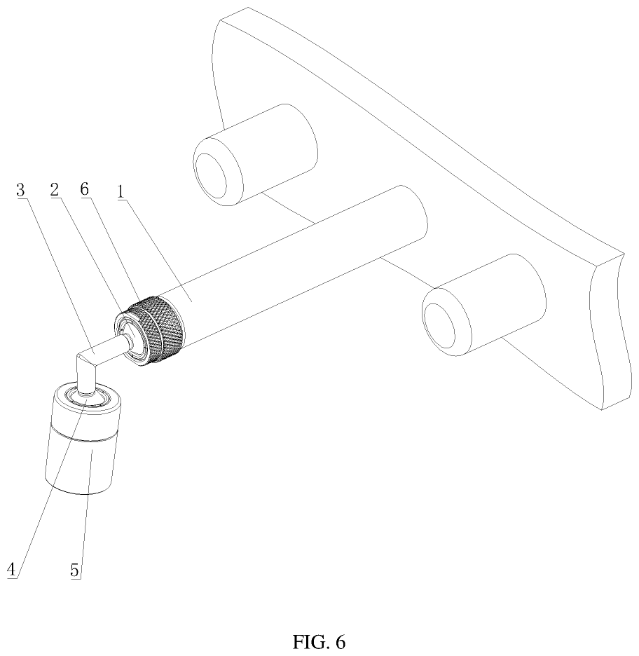

The faucet can be used on many occasions. As shown in FIG. 6, the faucet is a hidden faucet mounted on a wall, water flows through the horizontal water outlet end 1, the first water channel, the second water channel and the third water channel and then flows out of the aerator, and the rotation angle of the first ball 2 and the rotation angle of the second ball 4 can be adjusted to allow water to be discharged in different directions.

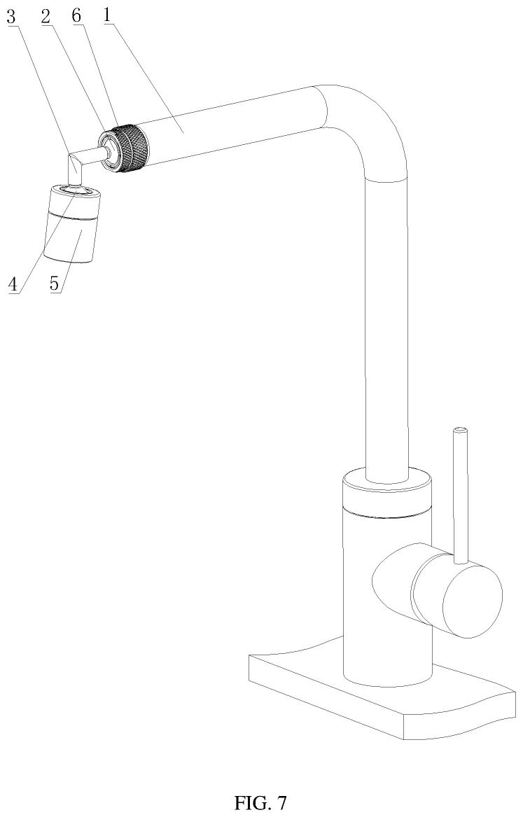

As shown in FIG. 7, the faucet is a kitchen faucet mounted on a table board, water flows through the horizontal water outlet end 1, the first water channel, the second water channel and the third water channel and then flow out of the aerator, and the rotation angle of the first ball 2 and the rotation angle of the second ball 4 can be adjusted to allow water to be discharged in different directions.

To sum up, according to the faucet provided by the invention, through the first ball rotatably arranged in the water outlet end, the water outlet in the surface of one end of the connecting piece can discharge water upwards, downwards, leftwards, rightwards, forwards and backwards; moreover, the first ball can be pushed into the water outlet end to occupy less space and to protect the connecting piece; the water outlet direction can be adjusted more flexibly through the second ball and the water outlet component; the connecting piece is a bent metal flexible hose, so that more water outlet angles can be provided, and the bending angle of the metal flexible hose can be fixed freely; and the mating part is connected to the first ball and the water outlet end and is provided with anti-slip stripes, so that assembly and disassembly are facilitated.

The above description is merely used to explain the embodiments of the invention, and is not intended to limit the patent scope of the invention. All equivalent transformations made according to the contents of the specification and the accompanying drawings, or direct or indirect applications to relating technical fields should also fall within the patent protection scope of the invention.

What is claimed is:

1. A faucet, comprising a water outlet part and a rotatable water outlet assembly, wherein a water outlet end of the water outlet part is arranged horizontally, and the rotatable water outlet assembly is connected to the water outlet end.

2. The faucet according to claim 1, wherein the water outlet assembly comprises a first ball and a connecting piece, the first ball is rotatably arranged in the water outlet end, and a first water channel penetrates through the first ball and is connected to the water outlet end; one end of the connecting piece is connected to the first ball, a second water channel is formed in the connecting piece, the first water channel is communicated with the second water channel, and a water outlet is formed in another end of the connecting piece.

3. The faucet according to claim 2, wherein the water outlet assembly further comprises a second ball and a water outlet component, a third water channel penetrates through the second ball, the two ends of the connecting piece are connected to the first ball and the second ball respectively, and the first water channel, the second water channel and the third water channel are communicated sequentially; and the second ball is rotatably arranged in the water outlet component.

4. The faucet according to claim 3, wherein the water outlet component is an aerator.

5. The faucet according to claim 2, wherein the connecting piece is bent.

6. The faucet according to claim 2, wherein the connecting piece is a hollow rod piece.

7. The faucet according to claim 2, wherein the connecting piece is a metal flexible hose.

8. The faucet according to claim 2, wherein the water outlet assembly further comprises a mating part, the first ball is rotatably arranged at one end of the mating part, and another end of the mating part is connected to the water outlet end in a threaded manner.

9. The faucet according to claim 8, wherein the mating part extends out of the water outlet end, and anti-slip stripes are arranged on a circumferential surface of an extending section of the mating part.
